(19) United States
(12) Patent Application Publication
(10) Pub. No.: US 2010/0076815 A1
(43) Pub. Date: Mar. 25, 2010

(54) STORAGE OPTIMIZATION FOR UPDATED USER BEHAVIORAL PROFILE SCORES

(75) Inventor: Ankur Jain, Cupertino, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/237,323

(22) Filed: Sep. 24, 2008

(51) Int. Cl. G06Q 30/00

(52) U.S. Cl. 705/10

(57) ABSTRACT

Scores are maintained usable by a behavioral targeting service for providing personalized content, such as advertisements. Event indications are processed, wherein the event indications being processed are indicative of user interaction generally with at least one online. It is determined, based at least in part on detected events (usable for scoring), scoring data indicative of user behavior relative to the at least one online service for each of a plurality of targeting categories. This includes updating the scoring data based on additional event indications being detected as being usable for generating scoring data for behavioral targeting. The updated scoring data is caused to be provided to the data store accessible to the behavioral targeting service when it has been determined that the updated scoring data will change the operation of the behavioral targeting service with respect to personalized content that would be served based on the updated scoring data.

### CROSS-REFERENCE TO RELATED APPLICATIONS

This application is related to co-pending U.S. application Ser. No. ______, filed on an even date herewith, entitled “PRIMARY-SECONDARY CACHING SCHEME TO ENSURE ROBUST PROCESSING TRANSITION DURING MIGRATION AND/OR FAILOVER” (Atty. Docket No.: YAH1P166), and to co-pending U.S. application Ser. No. ______, filed on an even date herewith, entitled “DATED METADATA TO SUPPORT MULTIPLE VERSIONS OF USER PROFILES FOR TARGETING OF PERSONALIZED CONTENT” (Atty. Docket No.: YAH1P168), both of which are incorporated herein by reference in their entirety for all purposes.

### BACKGROUND

FIG. 1, which does not illustrate the present invention, illustrates an architecture of a system in which front end web servers FEa 102a, FEb 102b, FEc 102c, . . . , FEx 102x, including front end web servers handling search events, are producing event data 105 based on incoming user requests 103. There may be many types of events. For example, a web portal such as provided by Yahoo, Inc. may include numerous different “sites,” such as “Sports,” “Finance” and “Search.” These are just a few examples of possible sites and, in practice, the portal may include many more sites.

In the FIG. 1 architecture, the event data 105 is provided to data collectors DC1 108(1) and DC2 108(2) via paths Pa 106a, Pb 106b, Pc 106c and Pd 106d. In general, there may be numerous front end web servers, data collectors and paths; a small number are shown in FIG. 1 and throughout this patent description for simplicity of illustration. The particular paths may be determined according to a path configuration 104, for example, as described in U.S. patent application Ser. No. 11/734,067 (Attorney Docket number YAH1P079), filed on Apr. 11, 2007. U.S. patent application Ser. No. 11/734,067 is incorporated by reference at least for its disclosure of methods to determine path configurations.

The data collectors may be, for example, computers or computer systems in one or more data centers. A data center is a collection of machines (data collector machines) that are co-located (i.e., physically proximally-located). The data centers may be geographically dispersed to, for example, minimize latency of data communication between front end web servers and the data collectors. Within a data center, the network connection between machines is typically fast and reliable, as these connections are maintained within the facility itself. Communication between front end web servers and data centers, and among data centers, is typically over public or quasi-public networks (i.e., the internet).

The events provided from the front end web servers to the data collectors may be provided to one or more data warehouses, using a construct known by some as a “data highway.” In some examples, the data highway has “off ramps” via which various events may be detected and use for functions such as generating scores for use in targeting advertisements to users based on past behavior of the users.

### SUMMARY

In accordance with an aspect, scores are maintained usable by a behavioral targeting service for providing personalized content, such as advertisements. Event indications are processed, wherein the event indications being processed are indicative of user interaction generally with at least one online service (and, for example, may be provided to persistent storage from data collectors associated with the at least one online service). Some of the event indications are indicative of events usable for generating scoring data for behavioral targeting for providing personalized content (such as advertisements). The processing of event indications includes detecting event indications that are indicative of events usable for generating scoring data for behavioral targeting.

It is determined, based at least in part on the detected events, scoring data indicative of user behavior relative to the at least one online service for each of a plurality of targeting categories. This includes updating the scoring data based on additional event indications being detected as being usable for generating scoring data for behavioral targeting. It is further determined whether to cause the updated scoring data to be provided to a data store accessible to a behavioral targeting service, based on a determination of whether the updated scoring data will change the operation of the behavioral targeting service with respect to advertisements that would be served based on the updated scoring data. The updated scoring data is caused to be provided to the data store accessible to the behavioral targeting service when it has been determined that the updated scoring data will change the operation of the behavioral targeting service with respect to personalized content that would be served based on the updated scoring data. For example, it may be determined whether a targeting threshold has been crossed and, if not, then the updated scoring data may not be provided to the data store accessible to the behavioral targeting service.

### BRIEF DESCRIPTION OF THE DRAWINGS

FIG. 1, which does not illustrate the present invention, illustrates an architecture of a system in which event indications, generated as a result of user interaction with online services, is provided to data collectors, for providing to persistent storage, such as in a data warehouse.

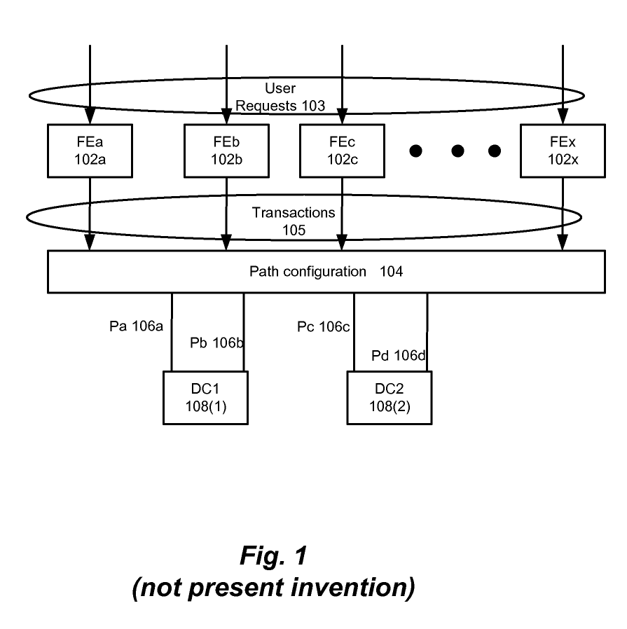

FIG. 2 illustrates how event indications may be provided to a scoring engine as the event indications are provided for persistent storage.

FIG. 3 broadly illustrates an architecture of a system including a scoring engine that generates updated targeting scores and provides updated scores to online data stores at targeting data centers as determined to be appropriate.

FIG. 4 illustrates an example of thresholds that may be used as criteria in determining when it is appropriate to provided updates scores to online data stores at targeting data centers.

FIG. 5 is a combination timeline and data flow diagram that summarizes how, in one example, an event on the data highway may (or may not) result in an updated score being provided to an online store in the advertising server data centers.

FIG. 6 is a diagram of an example targeting-centric logical architecture.

FIG. 7 is a simplified diagram of a network environment in which specific embodiments of the present invention may be implemented.

### DETAILED DESCRIPTION

The inventors have realized the desirability of not only centrally computing scores usable for targeting advertisements to users based on past behavior of the users but, also, that resources can be conserved by only transmitting updated scores to targeting servers when the updated scores would change the targeting behavior of the targeting servers from the previous scores, prior to updating.

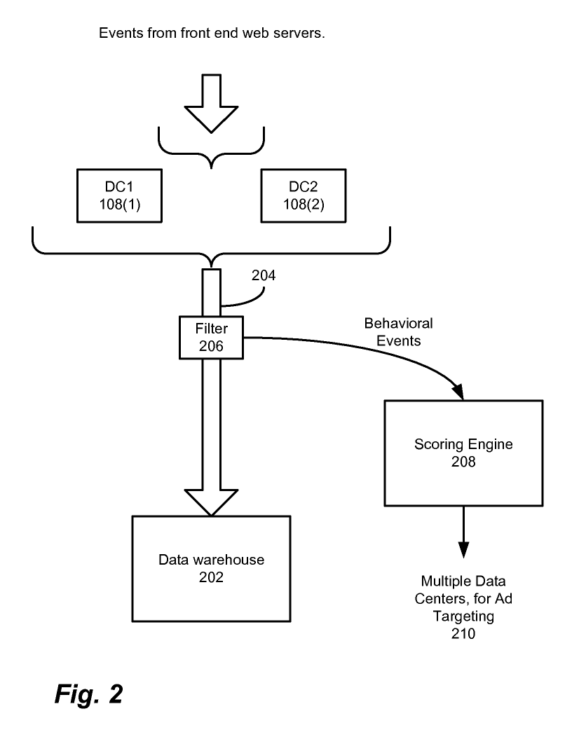

Referring now to FIG. 2, the event data provided to the data collectors DC1 108(1) and DC2 108(2) via paths Pa 106a, Pb 106b, Pc 106c and Pd 106d are further provided to a data warehouse 202 via what may be thought of as a “data highway” 204. For example, every event may be indicated by an event record that includes fields whose contents characterize the event. For example, an event record may include a field whose contents identify a “host name” or “space id” corresponding to a front end server that that generated the event. A “space id” is a unique key that identifies the page contents and category. In addition, the event record may include a “user id” that uniquely correlates to a particular user. Particular events that satisfy particular criteria may be provided from the data highway, as they are provided for persistent storage, using a data offramp. More particularly, the data offramp operates as a selector to select events on the data highway that satisfy the particular criteria.

A scoring engine 208 may then use the “behavioral events” to generate scores for particular users in particular categories, where the generated scores are representative of the behavior of the particular users with respect to those particular categories. Thus, for example, the generated scores may be utilized by targeting functionality to target each particular user with advertisements based on how that user has previously interacted with the sites of the web portal and how that user is presently interacting with the sites of the web portal. This behavioral-based targeting may be used in combination with targeting based on demographic information of the user, as well as geographic information of the user. That is, when a user requests a particular web page, a score for that user, where the score is associated with a category to which the requested particular web page corresponds, may be processed to determine an advertisement to display to that user in association with the requested particular web page. Generally, the better targeted the web page is to the user's past behavior (i.e., to behavior with respect to web pages in the same category as the particular web page requested by the user), the higher a price the web page publisher may command from the advertiser. The general concept of scoring and targeting is well known.

The advertisements are served from geographically-distributed data centers 210. The targeting scores are thus provided to multiple data centers 210 for use in the advertisement targeting process.

The inventor has realized that the process of computing and updating user scores to multiple data centers can be highly bandwidth intensive. For example, one portal may result in as many as eight billion events per day, which would result in updating the scores at the multiple data centers eight billion times per day. The inventor has realized, however, that the scores need not be updated to the multiple data centers based on every event. Rather, it is advantageous to maintain an “internal” state of the scores and to update the scores at the multiple data centers only when particular criteria are met, such as when an internal score for a user has changed such that, if available at the data centers, the advertisement determination behavior for that user would be different than if the score were not updated. Thus, for example, the number of updates may be as few as five hundred million per day, rather than eight billion updates per day.

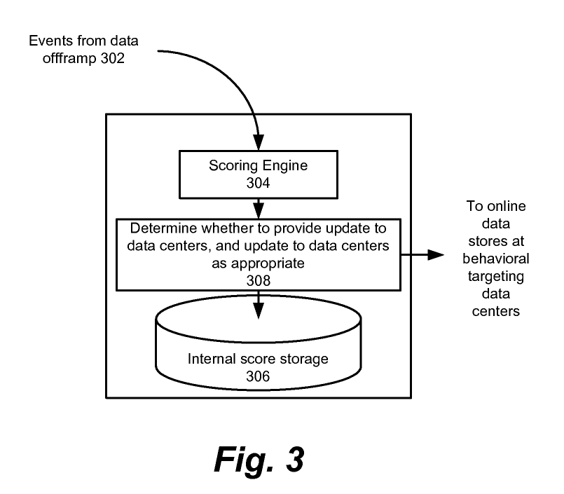

For example, as illustrated in FIG. 3, events 302 may be provided to a scoring engine from a data offramp of a data highway. As discussed in the background, the data highway is how event data provided to data collectors are provided to a data warehouse for persistent storage. The data offramp includes filtering functionality to select those events that meet particular criteria including, generally, events from which it can be determined what is users' behavior with respect to various advertisement targeting categories. Based on the events, scoring engine 304 determines updated category scores for the users, based on previously-determined scores held locally in an internal store 306, and provides the updated scores back to the internal store 306. For example, based on the events, the scoring engine 304 may increase the previously-determined score held in the internal store 306 and provide the increased score back to the internal store 306.

An update determination function 308 operates to determine if the updated scores meet particular criteria such that the updated scores should be provided to the data centers. For example, the scores may be numbers, and the advertisement targeting model may be such that numbers within a particular range all result in the same advertisement targeting. Put another way, the advertisement targeting may not change until the numerical targeting score crosses a particular threshold. This is one example, and other examples are possible.

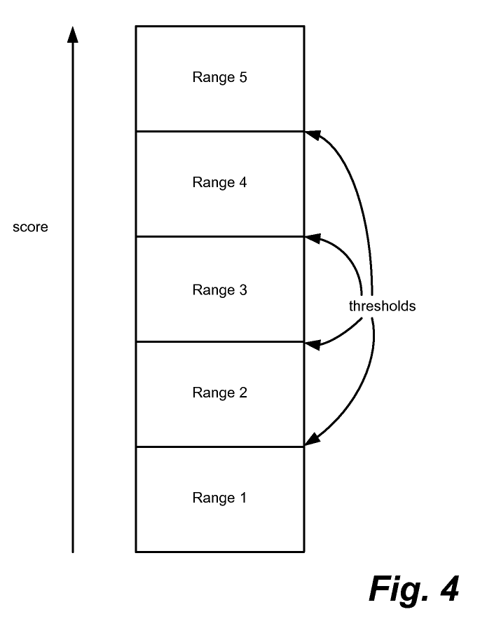

FIG. 4 illustrates, in a simplistic fashion, the example in which score numbers within a particular range all result in the same advertisement targeting. Referring to FIG. 4, a first range for the score for a particular user for a particular targeting category may fall within one of five ranges—from lowest to highest, Range 1 to Range 5. For example, if the score is an integer between 0 and 100, Range 1 may correspond to a score between 0 and 20, whereas Range 3 may correspond to a score between 200 and 300. While the ranges in FIG. 4 are shown as being of equal size, this need not be the case in all instances. In any event, there are thresholds between each range which, in FIG. 4, include the thresholds between Range 1 and Range 2, between Range 2 and Range 3, between Range 3 and Range 4, and between Range 4 and Range 5. While FIG. 4 is illustrated such that the ranges are static and all the same size, there are many different possible variations.

Referring back to FIG. 3, then, the particular criteria used by the update determination function 308, to determine if the updated scores should be provided to the data centers, may include whether the updating of a score causes that score to cross a threshold between scoring ranges such as the thresholds illustrated in FIG. 4. If the updating of a score does not cause that score to cross a threshold between scoring ranges, then there is no need to use the bandwidth and other resources to provide the updated score to the data centers, since the advertising targeting will not modified based on the updated score.

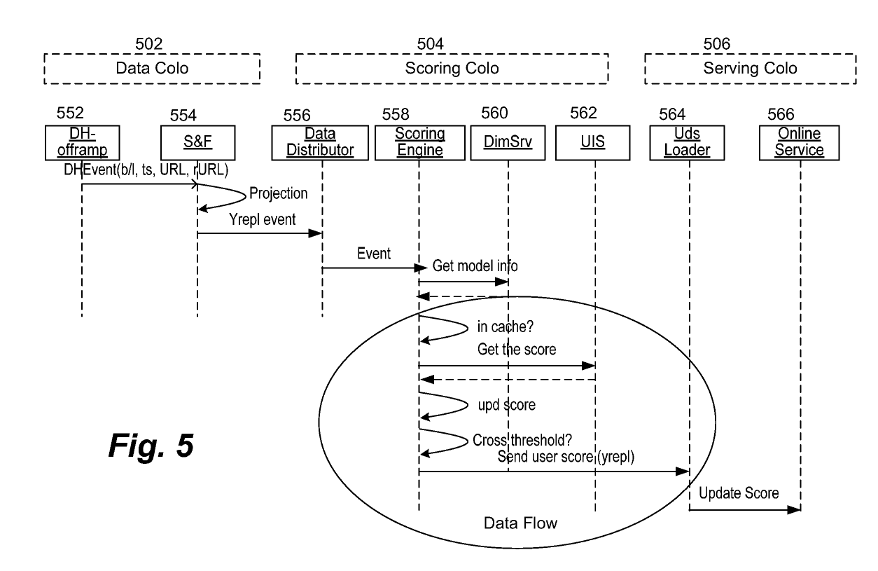

FIG. 5 is a combination timeline and data flow diagram that summarizes how, in one example, an event on the data highway may (or may not) result in an updated score being provided to an online store in the advertising server data centers. More particularly, the timeline and data flow diagram summarizes operations at the data center 502 (the source of events being provided for persistent storage), the scoring center 504 (which process the events affecting scores used for advertisement targeting) and the advertisement targeting center 506.

Starting from the left side of FIG. 5, a data highway off-ramp 552 receives data highway events with various parameters that characterize the events. Stream and forward components 554 are co-located with the data highway off-ramps 552, collecting the user activity data from the off-ramps 552 and forwarding the user activity data to a data distributor 556 of the scoring data center 504 using, in this specific example, a “yrepl” event, which is an event that is provided using a particular protocol that is understood by both the data servers 502 and the scoring servers 504. The data distributor 556 of the scoring center 504 provides the event to a scoring engine 558 of the scoring center 504. The scoring engine queries a dimension service 560 to get information about the scoring model via which to update a score based on the received event. The dimension service 560 holds the model data. The scoring engine 558 then retrieves the current score (whether from local cache or from a user internal state store 562 maintained at the scoring center 504). Metadata 620 provides information about the models, such as which model to use, how to configure the scoring engine 558, etc.

The scoring engine 558 updates the score based on the received event, according to the appropriate scoring model. Then the scoring engine 558 determines if the updated score has crossed a threshold in the targeting model, such that the updated score should be provided to the serving center 506. If the scoring engine 558 determines that the updated score should be provided to the serving center 506, then the updated user score is provided, using a yrepl message, to a user data store uploader 564 of the serving center 506, which handles uploading the updated score to the online data store 566, where it is available for use by the behavior targeting functionality of the advertisement targeting center 506.

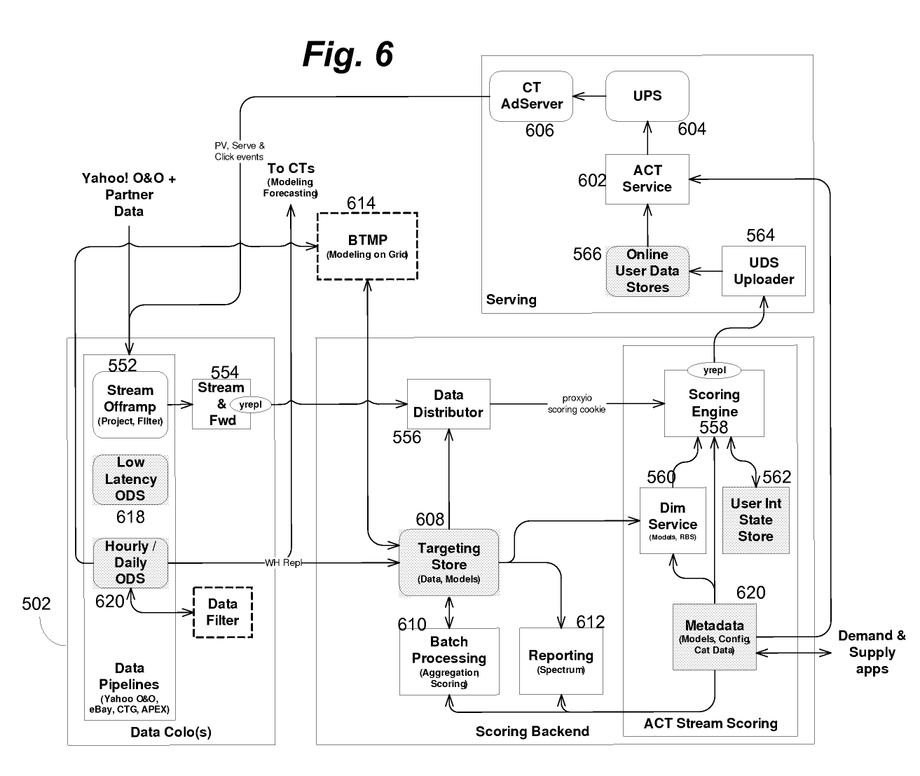

These components are also shown in FIG. 6, which is diagram of an example targeting-centric logical architecture. For completeness, in addition to components discussed with reference to FIG. 5 that are more directly involved with providing data for behavioral targeting, other “support” components are also now discussed. Referring to FIG. 6, in the serving data center 506, the ACT (Audience Centric Targeting) Service component 602 applies final decays, score adjustments, combinations, etc to the score components in user profile. The application of delays, score adjusting and other operations is also accounted for by the scoring engine 558, such that updated scores maintained in the user internal state store 562 are in synchronization with the scores used by the ACT Service 602 for targeting. The UPS (User Profile Service) component 604 is a brokering service that federates calls for targeting/personalization data across multiple stores and/or services. The CT (Connection Tactic) server component 606 performs ad matching and serving for a Connection Tactic (Guaranteed Delivery, Non guaranteed delivery, etc).

We now turn to the components that are more relevant to the raw data of the received events. For example, the targeting store component 608 is an operational data store containing raw events (pageviews, adviews, adclicks, etc) that are provided from operational data stores for various data collection pipelines from multiple data collection services, that are used by the targeting systems and may also be provided to a research store 616 for use by research modeling processing 614. For example, the low latency operational data store (ODS) 618 and hourly/daily ODS 620 are operational data stores that provide data feeds to various (internal) consumers and to the targeting store component 608. Low latency ODS has data available at latencies of 1 h or less while the hourly/daily ODS provides at latencies of two hours or more. The data retention in this store is typically twenty-eight days or lower. The batch processing component 610 does daily aggregation on this raw data and these daily aggregations are provided to the scoring engine 558 in addition to streaming events. The reporting component 612 is an internal reporting system usable to inspect how well scoring models are performing.

The Behavioral Targeting Modeling Platform (BTMP) 614 is a modeling component that uses data from the targeting store 608 to generate models that may be used for research and/or for generating models for the production system.

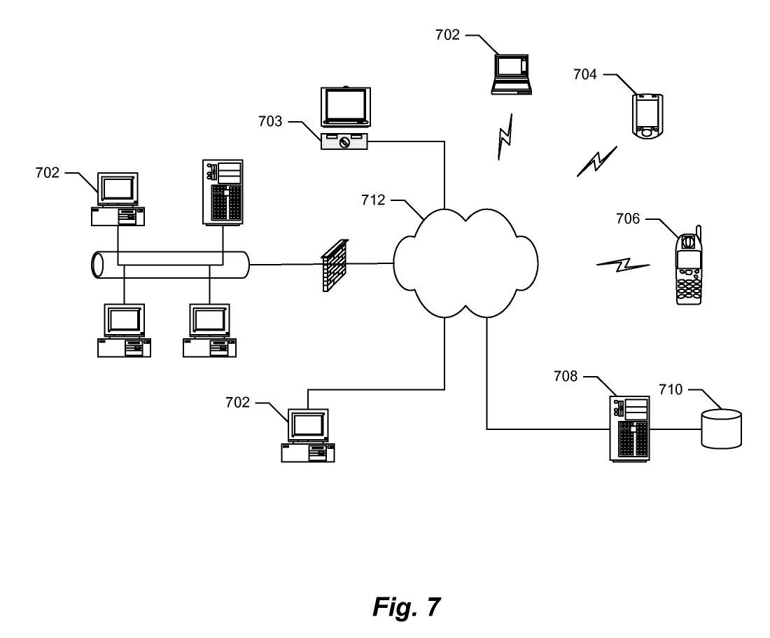

Embodiments of the present invention may be employed to configure presence indications in a wide variety of computing contexts. For example, as illustrated in FIG. 7, implementations are contemplated in which users may interact with a diverse network environment via any type of computer (e.g., desktop, laptop, tablet, etc.) 702, media computing platforms 703 (e.g., cable and satellite set top boxes and digital video recorders), handheld computing devices (e.g., PDAs) 704, cell phones 706, or any other type of computing or communication platform.

According to various embodiments, applications may be executed locally, remotely or a combination of both. The remote aspect is illustrated in FIG. 7 by server 708 and data store 710 which, as will be understood, may correspond to multiple distributed devices and data stores.

The various aspects of the invention may also be practiced in a wide variety of network environments (represented by network 712) including, for example, TCP/IP-based networks, telecommunications networks, wireless networks, etc. In addition, the computer program instructions with which embodiments of the invention are implemented may be stored in any type of tangible computer-readable media, and may be executed according to a variety of computing models including, for example, on a stand-alone computing device, or according to a distributed computing model in which various of the functionalities described herein may be effected or employed at different locations.

What is claimed is:

1. A method of maintaining scores usable by a behavioral targeting service for providing personalized content, comprising:
processing event indications, wherein the event indications being processed are indicative of user interaction generally with at least one online service, wherein some of the event indications are indicative of events usable for generating scoring data for behavioral targeting for providing personalized content, the processing of event indications to detect event indications that are indicative of events usable for generating scoring data for behavioral targeting;
processing the detected event indications of the event indications, and determining based at least in part thereon, scoring data indicative of user behavior relative to the at least one online service for each of a plurality of targeting categories, including updating the scoring data based on additional event indications being detected as being usable for generating scoring data for behavioral targeting; and
determining whether to cause the updated scoring data to be provided to a data store accessible to a behavioral targeting service, based on a determination of whether the updated scoring data will change the operation of the behavioral targeting service with respect to advertisements that would be served based on the updated scoring data; and
causing the updated scoring data to be provided to the data store accessible to the behavioral targeting service when it has been determined that the updated scoring data will change the operation of the behavioral targeting service with respect to personalized content that would be served based on the updated scoring data.

2. The method of claim 1, further comprising:
avoiding causing the updated scoring data to be provided to the data store accessible to the behavioral targeting service when it has been determined that the updated scoring data will not change the operation of the behavioral targeting service with respect to personalized content that would be served based on the updated scoring data.

3. The method of claim 2, wherein:
avoiding causing the updated scoring data to be provided to the data store accessible to the behavioral targeting service includes maintaining the updated scoring data in a data store local to a scoring engine that is determining the updated scoring data.

4. The method of claim 1, wherein:
the event indication processing is of event indications being provided to persistent storage from data collectors associated with the at least one online service; and
the method further comprises persistently storing the event indications that are being provided to persistent storage from the data collectors associated with the at least one online service and are being processed to detect event indications that are usable for generating scoring data for advertisement behavioral targeting.

5. The method of claim 1, wherein:
the personalized contents includes advertisements, such that the behavioral targeting for providing personalized content includes behavioral targeting for providing advertisements.

6. The method of claim 1, further comprising:
determining that the updated scoring data will change the operation of the behavioral targeting service with respect to personalized content that would be served based on the updated scoring data by determining if the updated scoring data has crossed a targeting threshold so as to change the operation of the behavioral targeting service.

7. The method of claim 1,
wherein determining whether to cause the updated scoring data to be provided to the data store accessible to the behavioral targeting service includes considering adjustments to the updated scoring data that would be made by the behavioral targeting service if the updated scoring data is provided to the data store accessible to the behavioral targeting service.

8. A method to maintain scores usable by a behavioral targeting service for providing personalized content, comprising:
determining based at least in part on event indications that are indicative of user interaction generally with at least one online service, scoring data indicative of user behavior relative to the at least one online service for each of a plurality of targeting categories, including updating the scoring data based on additional event indications being detected as being usable for generating scoring data for behavioral targeting; and
determining whether to cause the updated scoring data to be provided to a data store accessible to a behavioral targeting service, based on a determination of whether the updated scoring data will change the operation of the behavioral targeting service with respect to advertisements that would be served based on the updated scoring data; and
causing the updated scoring data to be provided to the data store accessible to the behavioral targeting service when it has been determined that the updated scoring data will change the operation of the behavioral targeting service with respect to personalized content that would be served based on the updated scoring data.

9. A system configured to maintain scores usable by a behavioral targeting service to provide personalized content, the system comprising:
a event indication detection component configured to process event indications, wherein the event indications being processed are indicative of user interaction generally with at least one online service, wherein some of the event indications are indicative of events usable for generating scoring data for behavioral targeting for providing personalized content, the processing of event indications to detect event indications that are indicative of events usable for generating scoring data for behavioral targeting;
a scoring engine component configured to:
process the detected event indications of the event indications, and to determine based at least in part thereon, scoring data indicative of user behavior relative to the at least one online service for each of a plurality of targeting categories, including updating the scoring data based on additional event indications being detected as being usable for generating scoring data for behavioral targeting;
determine whether to cause the updated scoring data to be provided to a data store accessible to a behavioral targeting service, based on a determination of whether the updated scoring data will change the operation of the behavioral targeting service with respect to advertisements that would be served based on the updated scoring data; and
cause the updated scoring data to be provided to the data store accessible to the behavioral targeting service when it has been determined that the updated scoring data will change the operation of the behavioral targeting service with respect to personalized content that would be served based on the updated scoring data.

10. The system of claim 9, wherein the scoring engine is further configured to:
avoid causing the updated scoring data to be provided to the data store accessible to the behavioral targeting service when it has been determined that the updated scoring data will not change the operation of the behavioral targeting service with respect to personalized content that would be served based on the updated scoring data.

11. The system of claim 10, wherein:
being configured to avoid causing the updated scoring data to be provided to the data store accessible to the behavioral targeting service includes being configured to maintain the updated scoring data in a data store local to a scoring engine that is determining the updated scoring data.

12. The system of claim 9, wherein:
the event indication processing component is configured to process event indications being provided to persistent storage from data collectors associated with the at least one online service; and
the system further comprises the persistent storage to store the event indications that are being provided to persistent storage from the data collectors associated with the at least one online service and are being processed to detect event indications that are usable for generating scoring data for advertisement behavioral targeting.

13. The system of claim 9, wherein:
the personalized contents includes advertisements, such that the behavioral targeting for providing personalized content includes behavioral targeting for providing advertisements.

14. The system of claim 9, wherein the scoring engine component is further configured to:
determine that the updated scoring data will change the operation of the behavioral targeting service with respect to personalized content that would be served based on the updated scoring data by determining if the updated scoring data has crossed a targeting threshold so as to change the operation of the behavioral targeting service.

15. The system of claim 9,
wherein being configured to determine whether to cause the updated scoring data to be provided to the data store accessible to the behavioral targeting service includes being configured to consider adjustments to the updated scoring data that would be made by the behavioral targeting service if the updated scoring data is provided to the data store accessible to the behavioral targeting service.

16. A computer program product to maintain scores usable by a behavioral targeting service for providing personalized content, the computer program product comprising at least one computer-readable medium having computer program instructions stored therein which are operable to cause at least one computing device to:
determine based at least in part on event indications that are indicative of user interaction generally with at least one online service, scoring data indicative of user behavior relative to the at least one online service for each of a plurality of targeting categories, including updating the scoring data based on additional event indications being detected as being usable for generating scoring data for behavioral targeting; and
determine whether to cause the updated scoring data to be provided to a data store accessible to a behavioral targeting service, based on a determination of whether the updated scoring data will change the operation of the behavioral targeting service with respect to advertisements that would be served based on the updated scoring data; and
cause the updated scoring data to be provided to the data store accessible to the behavioral targeting service when it has been determined that the updated scoring data will change the operation of the behavioral targeting service with respect to personalized content that would be served based on the updated scoring data.

17. The computer program product of claim 16, the computer program instructions further operable to cause at least one computing device to:
avoid causing the updated scoring data to be provided to the data store accessible to the behavioral targeting service when it has been determined that the updated scoring data will not change the operation of the behavioral targeting service with respect to personalized content that would be served based on the updated scoring data.

18. The computer program product of claim 17, wherein:
avoiding causing the updated scoring data to be provided to the data store accessible to the behavioral targeting service includes maintaining the updated scoring data in a data store local to a scoring engine that is determining the updated scoring data.

19. The computer program product of claim 16, wherein:
the event indication processing is of event indications being provided to persistent storage from data collectors associated with the at least one online service; and
the computer program instructions further operable to cause at least one computing device to persistently store the event indications that are being provided to persistent storage from the data collectors associated with the at least one online service and are being processed to detect event indications that are usable for generating scoring data for advertisement behavioral targeting.

20. The computer program product of claim 16, wherein:
the personalized contents includes advertisements, such that the behavioral targeting for providing personalized content includes behavioral targeting for providing advertisements.

21. The computer program product of claim 16, further comprising:
the computer program instructions further operable to cause at least one computing device to determine that the updated scoring data will change the operation of the behavioral targeting service with respect to personalized content that would be served based on the updated scoring data by determining if the updated scoring data has crossed a targeting threshold so as to change the operation of the behavioral targeting service.

22. The computer program product of claim 16,
wherein determining whether to cause the updated scoring data to be provided to the data store accessible to the behavioral targeting service includes considering adjustments to the updated scoring data that would be made by the behavioral targeting service if the updated scoring data is provided to the data store accessible to the behavioral targeting service.
